(19) United States
(12) Patent Application Publication
(10) Pub. No.: US 2015/0214710 A1
(43) Pub. Date: Jul. 30, 2015

(54) PORTABLE GROUNDING SYSTEM

(71) Applicant: Humberto Arenas, Bogota (CO)

(72) Inventor: Humberto Arenas, Bogota (CO)

(21) Appl. No.: 14/164,479

(22) Filed: Jan. 27, 2014

(51) Int. Cl. H02G 13/00; H01B 3/08

(52) U.S. Cl. CPC H02G 13/40; H02G 13/80; H01B 3/087

(57) ABSTRACT

The invention of the present application provides a portable grounding system that itself is an independent grounding system that can be placed to protect, independently or as a backup, an independent localized environment or an environment that is a subpart of a main environment for which the main environment grounding system could be failing because of broken joints between the wires that connect the main grounding system and its respective lightning rods.

### FIELD OF THE INVENTION

The system of the present invention is related to a portable grounding system that can be placed to protect, independently or as a backup, an independent localized environment or an environment that is a subpart of a main environment for which the main grounding system is failing because said main grounding system could be broken.

### BACKGROUND OF THE INVENTION

Lightning rays are a constant threat for locations or environments such as buildings, cellular antennas, and many other structures. Therefore, said environments are usually protected against lightning with lightning rods or similar devices connected to a grounding system by wires that are usually made of copper.

Sometimes, a grounding system fails to protect an environment because, e.g., the connection between a lightning rod and the respective grounding system is lost due to a broken welding that joints a part of the grounding system to the wire that connects said part to the lightning rod.

Lightning suppressor attenuators have been described (see United States Patent Application Publication US 2002/0171988 by Fowler et al.) that add to the grounding system attenuation of a lightning ray, wherein said added suppressor attenuator is inserted in a continuous way to the main grounding system. Therefore, if there is a broken welding that joints a wire connecting a lightning rod with a grounding system with an added suppressor attenuator, this grounding system with the added suppressor attenuator will fail.

This patent application describes a new invention that, as a backup of a main grounding system, protects specific environments in cases of failures of the main grounding system because, e.g., lost of the wire joints that connect the main grounding system to its respective lightning rods.

### SUMMARY OF THE INVENTION

The invention of the present application provides a portable grounding system that itself is an independent grounding system that can be placed to protect, independently or as a backup, an independent localized environment or an environment that is a subpart of a main environment for which the main environment grounding system could be failing because, e.g., broken joints between the wires that connect the main grounding system and its respective lightning rods.

Specifically, the present invention provides a portable grounding system that is characterized by:
A. a portable hermetic enclosure, wherein the hermetic enclosure is made of an isolating material that does not conduct electricity;
B. a first spiral electrical conductive wire that goes around along the length of the enclosure, wherein the first spiral electrical conductive wire has a first spiral ground wire lead from the outside of the enclosure;
C. a second spiral electrical conductive wire that goes around along the length of the enclosure , wherein the second spiral electrical conductive wire has a second spiral wire lead to the outside of the enclosure, wherein there is no physical contact between the first spiral electrical conductive wire and the second spiral electrical conductive wire; and,
D. a capacitive resistive compound that fills completely the inside of the hermetic enclosure, wherein the capacitive resistive compound suppresses any electrical current that could be carried by the first spiral conductive wire, and by the second spiral conductive wire, wherein the capacitive resistive compound fills between the first and the second spiral electrical conductive wires, and all other empty spaces inside the hermetic enclosure.

In one more aspect of the present invention the first and second spiral electrical conductive wires of the portable grounding system are made of copper.

In other aspect of the portable ground system of the present invention, the first spiral wire lead extends from outside the enclosure, wherein said first spiral wire lead is to be connected to a power source ground lead, and wherein the second spiral wire lead extends to the outside of the enclosure, wherein said second spiral wire lead is to be connected to an electric or electronic equipment ground lead.

In another aspect of the portable ground system of the present invention, capacitive resistive compound comprises an agglutinant, and a mixture of oxides, sulfates and hydroxides.

The present invention also provides a capacitive resistive compound for grounding systems, wherein the capacitive resistive compound is characterized by an agglutinant, and a mixture of oxides, sulfates and hydroxides.

Additional objectives and advantages of the present invention will be more evident in the description of the figures, the detailed description of the invention and the claims.

### BRIEF DESCRIPTION OF THE FIGURES

FIG. 1 shows tridimensional illustrations and a horizontal view of the portable grounding system of the present invention.

FIG. 2 shows a schematic representation of the portable grounding system of the present invention connected to an electrical equipment to be protected in a localized environment wherein the localized environment is linked to a main grounding system.

### DETAILED DESCRIPTION OF THE INVENTION

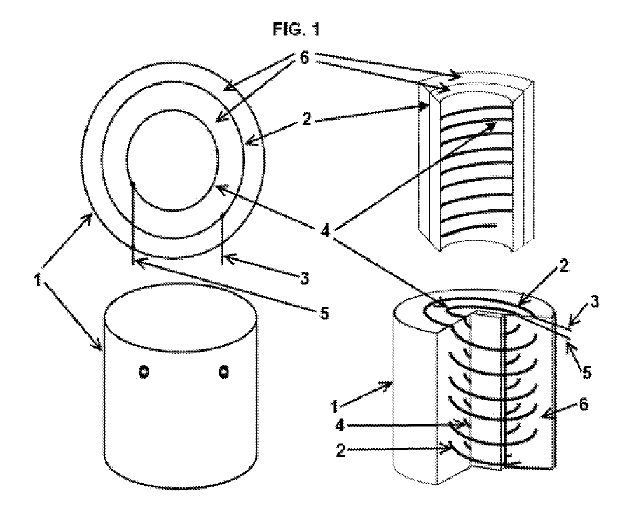

FIG. 1 shows the most preferred embodiment of the device of the present invention, wherein the portable grounding system is characterized by:
A. a portable hermetic enclosure (1), wherein the hermetic enclosure (1) is made of an isolating material that does not conduct electricity;
B. a first spiral electrical conductive wire (2) that goes around along the length of the enclosure (1), wherein the first spiral electrical conductive wire (2) has a first spiral ground wire lead (3) from the outside of the enclosure (1);
C. a second spiral electrical conductive wire (4) that goes around along the length of the enclosure (1) , wherein the second spiral electrical conductive wire (4) has a second spiral wire lead (5) to the outside of the enclosure (1), wherein there is no physical contact between the first spiral electrical conductive wire (2) and the second spiral electrical conductive wire (4); and,
D. a capacitive resistive compound (6) that fills completely the inside of the hermetic enclosure (1), wherein the capacitive resistive compound (6) suppresses any electrical current that could be carried by the first spiral conductive wire (2), and by the second spiral conductive wire (4), wherein the capacitive resistive compound (6) fills between the first (2) and the second (4) spiral electrical conductive wires, and all other empty spaces inside the hermetic enclosure (1).

In one more aspect of the present invention the first (2) and second (4) spiral electrical conductive wires of the portable grounding system are made of copper.

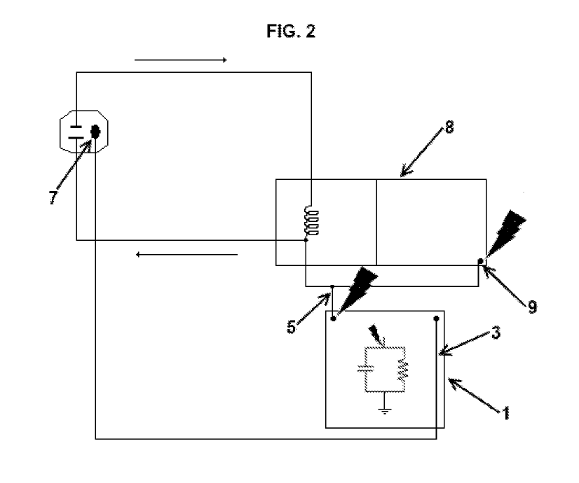

In other aspect of the portable ground system of the present invention, the first spiral wire lead (3) extends from outside the enclosure (1), wherein said first spiral wire lead (3) is to be connected to a power source ground lead (FIG. 2) (7), and wherein the second spiral wire lead (5) extends to the outside of the enclosure (1), wherein said second spiral wire lead (5) is to be connected to an electric or electronic equipment (FIG. 2) (8) ground lead (9).

In another aspect of the portable ground system of the present invention, capacitive resistive compound (6) comprises an agglutinant, and a mixture of oxides, sulfates and hydroxides.

The present invention also provides a capacitive resistive compound (6) for grounding systems, wherein the capacitive resistive compound (6) is characterized by an agglutinant, and a mixture of oxides, sulfates and hydroxides.

For purposes of the present invention the first (2) and second (4) spiral electrical conductive wires of the portable grounding system are made preferably of copper. However, the first (2) and second (4) spiral electrical conductive wires can also be made of any electrical conductive material metallic or non-metallic, as for example, steel, etc.

For purposes of the present invention the capacitive resistive compound (6) attenuates the current that is carried into the enclosure (1) by the first spiral electrical conductive wire (2). Said capacitive resistive compound is made of a mixture of oxides, sulfates and hydroxides, preferably, as follows:

OXIDES: SiO2, BaO2, CaO2, Fe2O3, Al2O3, MgO, Na2), K2O, MnO2, ZnO2, NiO2; SULFATES: SO3; CLHORIDES: NaYK; GRAPHITES; and, as a SOLVENT: mineralized water.

The preferred percentage ranges of the just described components of the capacitive resistive compound are as follows:

OXIDES %:

| Sio2 | 22 to 26 (Agglutinant) |
|---|---|
| BaO2 | 2 to 4 |
| CaO | 0.2 to 0.5 |
| Fe2O3 | 2 to 4 |
| Al2O3 | 7 to 9 (Agglutinant) |
| MgO | 1 to 3 |
| Na20 | 0.5 to 2 |
| K2O | 0.2 to 0.5 |
| MnO2 | <0.1 |
| ZnO2 | <0.1 |
| NiO2 | <0.1 |

SULFATES %:

| | |
|---|---|
| SO3 | 1 to 3 |

CLHORIDES %:

| | |
|---|---|
| Na and/or K | 5 to 8 |

GRAPHITES %:

| | |
|---|---|
| Graphite | 1 to 3 |

SOLVENT %:

| | |
|---|---|
| Mineralized water (Oxides) | 30 to 40 |

While the description presents the preferred embodiments of the present invention, additional changes can be made in the form and disposition of the parts without distancing from the basic ideas and principles comprised in the claims.

1. A portable grounding system comprising:
A. a portable hermetic enclosure, wherein the hermetic enclosure is made of an isolating material that does not conduct electricity;
B. a first spiral electrical conductive wire that goes around along the length of the enclosure, wherein the first spiral electrical conductive wire has a first spiral ground wire lead from the outside of the enclosure;
C. a second spiral electrical conductive wire that goes around along the length of the enclosure , wherein the second spiral electrical conductive wire has a second spiral wire lead to the outside of the enclosure, wherein there is no physical contact between the first spiral electrical conductive wire and the second spiral electrical conductive wire;
D. a capacitive resistive compound that fills completely the inside of the hermetic enclosure, wherein the capacitive resistive compound suppresses any electrical current that could be carried by the first spiral conductive wire, and by the second spiral conductive wire, wherein the capacitive resistive compound fills between the first and the second spiral electrical conductive wires, and all other empty spaces inside the hermetic enclosure.

2. The portable grounding system of claim 1, wherein the first and second spiral electrical conductive wires are made of copper.

3. The portable grounding system of claim 1, wherein the first spiral wire lead extends from outside the enclosure, wherein said first spiral wire lead is to be connected to a power source ground lead, and wherein the second spiral wire lead extends to the outside of the enclosure, wherein said second spiral wire lead is to be connected to an electric or electronic equipment ground lead.

4. The portable grounding system of claim 1, wherein capacitive resistive compound comprises an agglutinant, and a mixture of oxides, sulfates and hydroxides.

5. A capacitive resistive compound that comprises an agglutinant, and a mixture of oxides, sulfates and hydroxides.
